(19) United States
(12) Patent Application Publication
(10) Pub. No.: US 2012/0117841 A1
(43) Pub. Date: May 17, 2012

(54) TRIGGER FIT ADJUSTMENT APPARATUS AND METHOD

(75) Inventors: Seth Joubert, Pascoag, RI (US); Herb Belin, Springfield, MA (US)

(73) Assignee: SMITH & WESSON CORP., Springfield, MA (US)

(21) Appl. No.: 13/290,341

(22) Filed: Nov. 7, 2011

Related U.S. Application Data
(60) Provisional application No. 61/412,632, filed on Nov. 11, 2010.

(51) Int. Cl. F41A 19/10; B23P 17/04

(52) U.S. Cl. 42/69.01; 29/428

(57) ABSTRACT

An trigger assembly with an improved trigger fit adjustment apparatus located within a 1911 pistol fire control mechanism. The trigger assembly has a trigger bow and a trigger shoe. The trigger shoe is connected to a forward end of the trigger bow. The trigger shoe has a pair of substantially parallel sides, a lower end connecting each of the pair of substantially parallel sides, and a raised pad extending from a top surface. The raised pad has an upper end that is substantially parallel to the lower end. The upper end of the raised pad is vertically spaced from the top surface.

### CROSS REFERENCE TO RELATED APPLICATION

This application claims the benefit of U.S. Provisional Application No. 61/412,632, filed Nov. 11, 2010, entitled “IMPROVED TRIGGER FIT ADJUSTMENT APPARATUS AND METHOD”, the aforementioned application being hereby incorporated by reference in its entirety.

### FIELD OF THE INVENTION

The present invention relates to firearm fire control mechanisms and, more particularly, to improving trigger fit within a 1911 pistol fire control mechanism.

### BACKGROUND OF THE INVENTION

A typical 1911 pistol fire control mechanism includes a frame, a barrel mounted to a forward part or barrel bed of the frame, a slide mounted to the frame rearward of the barrel, and a fire control mechanism having components mounted within the slide and within the frame. The fire control mechanism components include a striker housed in the slide, a hammer mounted on a hammer pin within the frame, a sear mounted on a sear pin within the frame, a disconnector mounted on the same pin as the sear, and a trigger for actuating the sear, along with necessary springs.

The trigger includes a shoe and a bow. The bow is internal to the frame while the shoe protrudes out of the grip portion of the frame via a trigger slot, which is formed at the forward side of the grip portion of the frame adjacent to the middle portion of the frame. The shoe is enclosed by a trigger guard formed in the middle portion of the frame. The trigger bow is biased forward within the frame, but can be moved rearward by the shoe for actuating the sear (via the disconnector) to fire the pistol. The trigger bow contacts the bottom of the disconnector. When the trigger bow is pushed rearward by the user it forces the bottom of the disconnector to rotate rearward around the sear pin. A leaf style spring pushes the sear and the disconnector forward until the trigger bow is pushed rearward by the user squeezing the shoe.

Positioning of the trigger shoe within a 1911 pistol frame can affect perceived quality of operation. In particular, the shoe is held in its normal forward position by trigger grooves that are formed by side webs extending between the trigger guard and the frame. The shoe thickness and height help to determine how it moves along the grooves, with height being the dominant dimension. In particular, high spots on the trigger shoe can cause a sensation of hang up or pivoting when the trigger is squeezed. Thus, it is desirable to closely control fit of the trigger within the trigger grooves. However, known methods for controlling trigger fit require uniformly and repeatedly removing relatively small thicknesses of material from an entire end surface of a trigger. Thus, known methods for controlling trigger fit within the trigger grooves are time consuming, costly, and open to errors that are not easily corrected.

Similarly, relative positioning of the disconnector and the trigger bow, within the 1911 fire control mechanism, can affect perceived quality of operation. The disconnector is mounted on the sear pin by a square hole that defines a movement envelope for the disconnector. The square hole permits the disconnector to rotate on the sear pin, and to move vertically between an upward (engaged) position and a downward (disengaged) position. In the engaged position, the top of the disconnector stands proud of the frame and the disconnector engages (actuates) the sear when the bottom of the disconnector is rotated rearward around the sear pin. In the disengaged position, the top of the disconnector sits flush with the frame and the disconnector does not engage the sear when the bottom of the disconnector is rotated rearward around the sear pin.

When the bottom of the disconnector has fully rotated forward, the trigger bow may float free to move forward and rearward between the disconnector and the frame. This “play” of the trigger bow can result in a perception that the fire control mechanism is “loose” or of low quality. Accordingly, it is desirable to closely control fit of the trigger bow within the frame so that trigger bow play is prevented without defeating operation of the disconnector. However, controlling fit of the trigger bow has proven difficult in practice.

### SUMMARY OF THE INVENTION

According to embodiments of the present invention, a trigger apparatus comprising a trigger bow and a trigger shoe is provided with a raised pad at an end surface of the trigger shoe. The raised pad allows adjusting the height of the trigger shoe to match a mating trigger groove with minimal removal of material from the trigger shoe, and with reduced risk of causing an out-of-parallel condition during height adjustment. Removing material only from the raised pad results in the top finished surface of the trigger shoe remaining un-touched during final fit and assembly, enhancing usable life of the trigger.

According to embodiments of the present invention, a pistol assembly and inspection method includes verifying precise location of a forward trigger bow stop surface within a pistol frame. For example, a square or round gage plug may be used to determine the stop surface location relative to a reference datum.

According to embodiments of the present invention, a pistol frame includes a reference datum disposed along a first axis, and includes a trigger bow stop surface defining a plane perpendicular to a second axis. Distance from the stop surface plane to the first axis is verified to assure assembly of a fire control mechanism without trigger bow float.

These and other objects, features and advantages of the present invention will become apparent in light of the detailed description of the best mode embodiment thereof, as illustrated in the accompanying drawings.

### BRIEF DESCRIPTION OF THE DRAWINGS

The accompanying drawings, which are incorporated in and constitute a part of this specification, illustrate embodiments of the disclosure, and together with a general description of the disclosure given above, and the detailed description of the embodiments given below, serve to explain the principles of the disclosure.

FIG. 1 is a perspective view of a trigger assembly according to an embodiment of the present invention.

FIG. 2 is a side section view of a pistol frame housing a fire control mechanism that includes a trigger assembly in accordance with FIG. 1.

FIG. 3 is a top section view of the pistol frame, fire control mechanism, and trigger assembly in accordance with FIG. 2.

FIG. 4 is a schematic top section view illustrating a gage location within the pistol frame of FIGS. 2 and 3.

FIG. is a top plane view of the trigger assembly in accordance with FIGS. 1-3.

FIG. 6 a side plane view of the trigger assembly in accordance with FIGS. 1-3.

FIG. 7 an end plane view of the trigger assembly in accordance with FIGS. 1-3.

Other features and advantages of the present disclosure will become apparent from the following detailed description, taken in conjunction with the accompanying drawings, which illustrate, by way of example, the principals of the invention.

### DESCRIPTION OF PREFERRED EMBODIMENTS

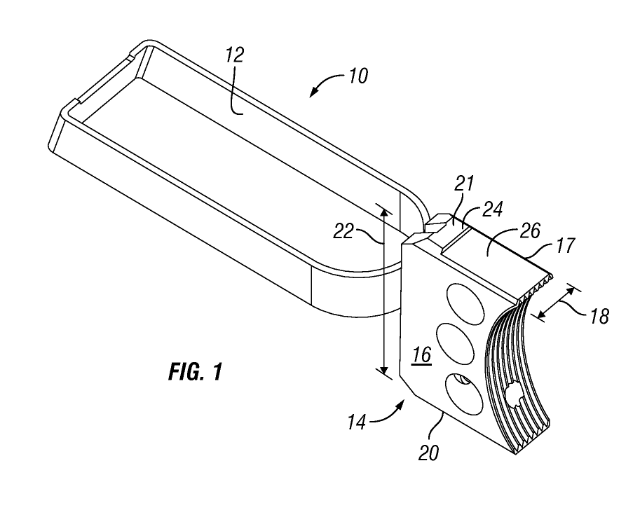

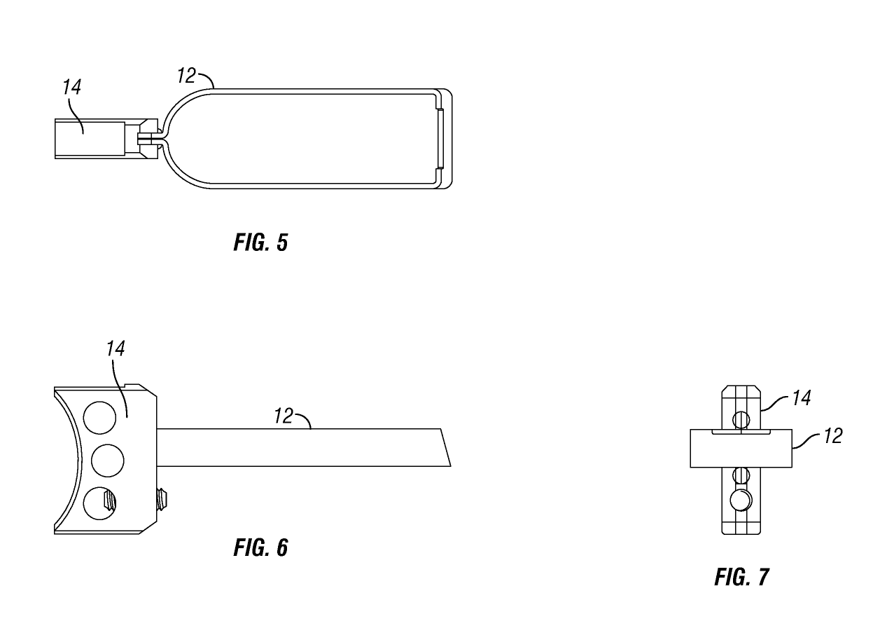

Referring to FIGS. 1 and 5-7, a trigger assembly 10 according to an embodiment of the present invention includes a trigger bow 12, which is swaged to a trigger shoe 14. The trigger shoe 14 has first and second side surfaces 16, 17 defining a thickness 18, and has lower and upper end surfaces 20, 21 defining a height 22. In FIG. 1, the lower end surface 20 extends the full length of the trigger shoe 14. By contrast, the upper end surface 21 is limited to the top of a raised pad 24, which protrudes from a top surface 26 extending forward from the raised pad 24, the full length of the trigger shoe 14. In the prior art, in order to fit a trigger shoe into a matching trigger groove, all of a top surface of the trigger shoe would need to be ground or filed down. By contrast, the presently disclosed trigger shoe 14 can be fitted to a matching trigger groove simply by filing down the raised pad 24.

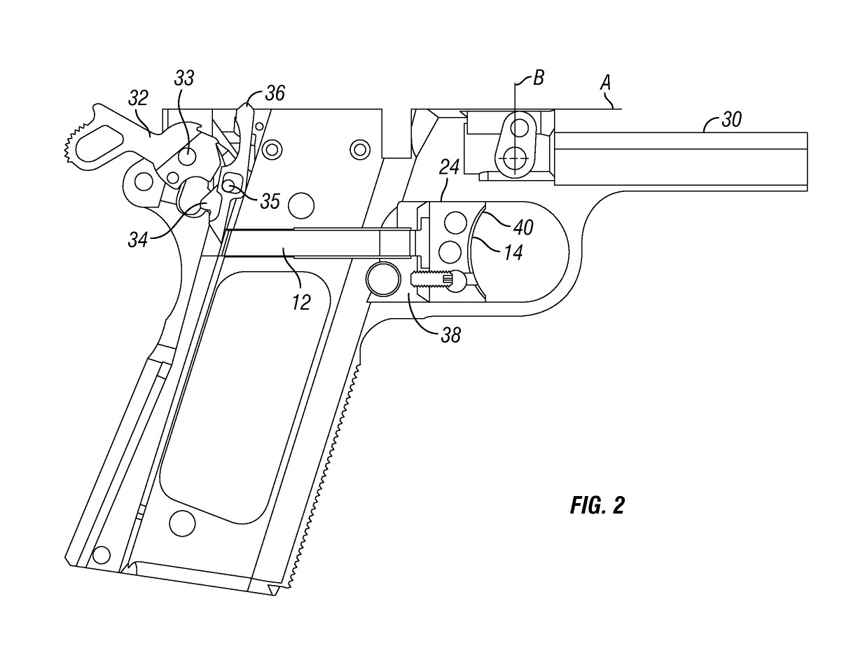

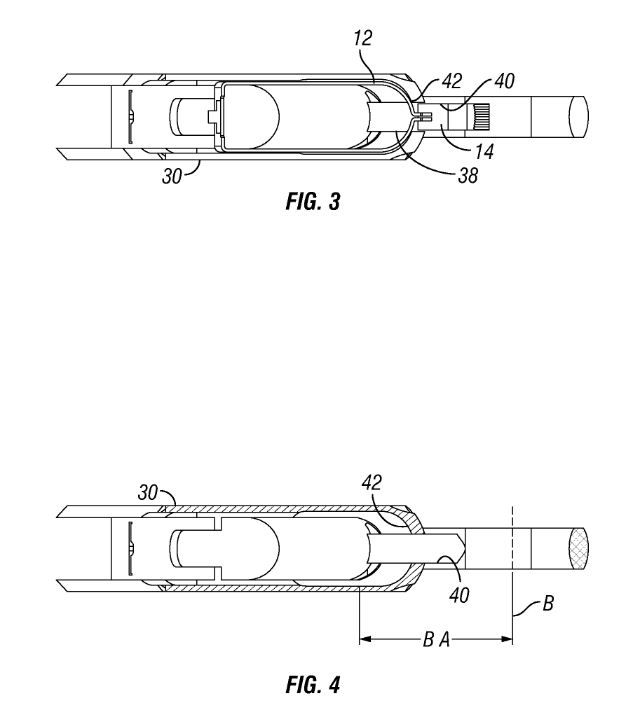

Referring to FIGS. 2-4, a pistol frame 30 houses the trigger bow 12 and a hammer 32 mounted on a hammer pin 33, a sear 34 mounted on a sear pin 35, and a disconnector 36 also mounted on the sear pin 35. With additional reference to FIG. 3, the frame 30 has a trigger slot 38 opened at a forward surface thereof, and has trigger grooves 40 extending forward from the trigger slot 38. The trigger shoe 14 slides forward and aft within the trigger grooves 40, and is adjusted to fit the trigger grooves 40 as described above.

The frame 30 also includes an inward-facing stop surface 42. The forwardmost position of the trigger bow 12 is set by this stop surface 42. Thus, the location of the stop surface 42, relative to the sear pin 35, controls whether the trigger bow 12 can move forward far enough to separate from the disconnector 36 and thereby cause forward and rearward play or float of the trigger shoe 14.

However, because the stop surface 42 is formed by two concave surfaces on opposing inside walls of the frame 30, it is challenging to verify the locating dimensions of the stop surface 42 and of the trigger bow 12. In particular it is difficult to physically measure the edge or depth of a radial cut. To get around this problem, a gage dimension BA was established, as shown in FIG. 4. The dimension BA defines the width of a gage plug inserted from the top of the frame to measure the location of the trigger slot stop surface 42 relative to a datum B better shown in FIG. 2. Adequate control of the dimension BA will ensure that the forward location of the trigger bow 12 will be sufficiently far from the sear-engagement position of the disconnector 36, but not too far forward.

A method for fitting the trigger assembly within the firearm is also provided. After providing the trigger assembly and firearm as discussed above, the distance between the stop surface and a datum plane is determined by inserting a gage (not shown for clarity) into the frame from the top. As a result, it is also determine if the distance between the stop surface and the sear pin is greater than or equal to a predetermined gage distance. If the distance is less than the predetermined gage distance, the frame is scrapped. If the distance is more or equal to the predetermined gage distance the trigger assembly is placed into the frame. If the trigger assembly cannot be inserted into the frame, a thickness is removed from the raised pad to allow the trigger shoe to slide within the trigger groove. The step may be repeated to ensure proper fit of the trigger shoe within the trigger groove. Then the trigger assembly is finally inserted into the frame to locate the trigger shoe within the trigger groove.

Although this invention has been shown and described with respect to the detailed embodiments thereof, it will be understood by those skilled in the art that various changes in form and detail thereof may be made without departing from the spirit and the scope of the invention.

What is claimed is:

1. A trigger assembly for use within a frame of a firearm to improve trigger fit adjustment, the trigger assembly comprising:
a trigger bow; and
a trigger shoe being connected to a forward end of the trigger bow and having:
a pair of sides,
a lower end surface connecting the pair of sides, and
a raised pad extending from a top surface and having an upper end surface being vertically spaced from the lower end surface, the upper end surface of the raised pad being vertically spaced from the top surface.

2. The trigger assembly according to claim 1, wherein the trigger bow and the trigger shoe being swaged together.

3. The trigger assembly according to claim 1, wherein the trigger shoe being adapted to slide along a trigger groove in the frame.

4. The trigger assembly according to claim 3, wherein the top surface of the trigger shoe is spaced from the lower end surface at a height that is substantially less than a height of the trigger groove.

5. The trigger assembly according to claim 3, wherein the upper end surface of the raised pad is spaced from the lower end surface at a height that is substantially equivalent to a height of the trigger groove.

6. The trigger assembly according to claim 1, wherein the upper end surface being substantially parallel to the lower end surface.

7. The trigger assembly according to claim 1, wherein the pair of sides are substantially parallel to each other.

8. The trigger assembly according to claim 1, wherein the lower end surface extends substantially the full length of the trigger shoe.

9. The trigger assembly according to claim 1, wherein the top surface extends forward from the raised pad.

10. A firearm comprising:
a frame having a trigger slot and a trigger groove extending forward from the trigger slot; and
a trigger assembly at least partially located within the trigger groove, the trigger assembly having:
a trigger bow;
a trigger shoe being connected to a forward end of the trigger bow and having:
a pair of sides,
a lower end surface connecting each of the pair of sides, and
a raised pad extending from a top surface and having an upper end surface vertically spaced from the lower end surface, the upper end surface of the raised pad being vertically spaced from the top surface.

11. The firearm according to claim 10, wherein the trigger bow and the trigger shoe being swaged together.

12. The firearm according to claim 10, wherein the trigger shoe being adapted to slide along the trigger groove of the frame.

13. The firearm according to claim 10, wherein the top surface of the trigger shoe is spaced from the lower end surface at a height that is substantially less than a height of the trigger groove.

14. The firearm according to claim 10, wherein the upper end surface of the raised pad is spaced from the lower end surface at a height that is substantially equivalent to a height of the trigger groove.

15. The firearm according to claim 10, wherein the upper end surface being substantially parallel to the lower end surface.

16. The firearm according to claim 10, wherein the pair of sides are substantially parallel to each other.

17. The firearm according to claim 10, wherein the lower end surface extends substantially the full length of the trigger shoe.

18. The firearm according to claim 10, wherein the top surface extends forward from the raised pad.

19. A method for fitting a trigger assembly within a firearm, the method comprising the steps of:
providing a frame having:
a trigger slot,
a trigger groove extending forward from the trigger slot,
a stop surface located rearward from the trigger groove, and
a sear pin spaced rearward from the stop surface;
providing a trigger assembly having:
a trigger bow; and
a trigger shoe being connected to a forward end of the trigger bow and having:
a pair of sides,
a lower end surface connecting the pair of sides, and
a raised pad extending from a top surface and having an upper end surface being vertically spaced from the lower end surface, the upper end surface of the raised pad being vertically spaced from the top surface;
determining the distance between the stop surface and the sear pin;
determining if the distance between the stop surface and the sear pin is greater than or equal to a predetermined gage distance;
removing a thickness from the raised pad to allow the trigger shoe to slide within the trigger groove; and
inserting the trigger assembly into the frame to locate the trigger shoe within the trigger groove.
